(19) United States
(12) Patent Application Publication
(10) Pub. No.: US 2007/0132149 A1
(43) Pub. Date: Jun. 14, 2007

(54) Methods of making foam nozzles for trigger dispensers

(76) Inventor: George R. Hildebrand, Independence, MO (US)

Correspondence Address: GORDON & JACOBSON, P.C., 60 LONG RIDGE ROAD, SUITE 407, STAMFORD, CT, 06902, US

(21) Appl. No.: 11/288,506

(22) Filed: Nov. 29, 2005

(51) Int. Cl. B29C 45/00

(52) U.S. Cl. 264/328.16; 239/333; 264/328.1

(57) ABSTRACT

Methods of making foaming nozzles for use with trigger sprayers are provided. The methods include molding a nozzle having a nozzle body containing a spray head and coupled by a live hinge to a door having a portal with a screen in the portal. The door is folded on the live hinge so that the door covers the spray head, and then substantially permanently on the nozzle body with the door covering the spray head.

### BACKGROUND OF THE INVENTION

1. Field of the Invention

This invention relates broadly to liquid dispensers. More particularly, this invention relates to methods of making having foam nozzles with screen doors for trigger dispensers.

2. State of the Art

Trigger dispensers are ubiquitous in most American homes. They are supplied on plastic bottles which are used to contain and dispense many different kinds of household liquids such as cleaning liquids, scenting liquids, garden liquids, etc. Traditionally, these sprayers have been provided with a rotatable nozzle which rotates among three positions: off, spray, and stream. More recently, it has been desirable to provide trigger dispensers with foaming nozzles.

The basic method of creating a foam is to discharge the liquid as a spray toward an obstruction that is vented to the atmosphere. The spray hitting the obstruction mixes the liquid spray with the air of the atmosphere producing the foam that is discharged from the nozzle. One simple way of achieving this is to put a screen in front of a conventional spray nozzle.

Most conventional spray nozzles are either cylindrical, frustroconical, or cubic. On a cubic nozzle, it is known to form a door with a live hinge extending from one of the exposed edges of the nozzle. The door is moveable from an open position where the outlet of the nozzle is not covered to a closed position where the outlet is covered. These doors may be used to protect the nozzle from dirt when the sprayer is not in use, minimize leaking from the nozzle when not in use, or they may be arranged to carry a screen and thereby make a spray nozzle dispense foam. In any case, the doors must be provided with some kind of locking mechanism which will hold them in the selected two positions (opened and closed).

nozzle doors lock to the opened or closed position with a frictional engagement. To lock the nozzle door in the opened position, it is known to provide frictionally engaging shoulders on one of the sides of the nozzle. The shoulders are, by necessity of nozzle dimensions, not very deep and thus do not securely engage the door. It is also known to provide an extension on the door with an orthogonal tongue which engages a mating groove or slot in the sprayer housing. This arrangement requires alterations to the sprayer housing as well as the nozzle and is thus more expensive to implement.

Co-owned co-pending application Ser. No. 11/xxx,xxx entitled “Foam and Spray Nozzles having a Hinged Door and a Trigger Dispenser Incorporating the Same” and filed on Nov. 22, 2005, discloses a nozzle having a hinged door which is movable between opened and closed positions and locks to the nozzle in both positions. The inventors herein recognize that it is not always necessary to provide a foaming nozzle with the ability to dispense a non-foaming spray or stream.

### SUMMARY OF THE INVENTION

It is therefore an object of the invention to provide a foaming nozzle for a trigger dispenser.

It is another object of the invention to provide a trigger dispenser with a foaming nozzle.

It is a further object of the invention to provide a foaming nozzle with a door which is lockable in a closed position and not readily opened.

It is also an object of the invention to provide a foaming nozzle which is inexpensive to manufacture.

It is an additional object of the invention to provide a foaming nozzle which is easy to assemble.

In accord with these objects, which will be discussed in detail below, the nozzle according to the invention has a front, a back, and at least one side surface extending therebetween. A spray head extends from the back of the nozzle towards the front of the nozzle. A door is provided with a portal within which a screen is mounted or molded. The door covers the front of the nozzle and the spray head and is locked, glued, chemically or sonically welded thereto, or otherwise substantially permanently closed thereon.

According to the presently preferred embodiment, as molded, the door is hingedly coupled to the front of the nozzle with a separate screen material insert molded or mechanically fixed to the door; alternatively, with a screen grid of homogenous material molded into the door. The door is provided with means for frictionally engaging the front of the nozzle to hold the door closed. Optionally, it may also be glued or welded shut. For example, the door may be provided with a pair of spaced apart hooks with a tongue therebetween which engage mating slots with a groove therebetween on the front of the nozzle. Alternatively, the hooks and slots are eliminated and only the tongue and groove frictionally engage to keep the door shut while it is glued or welded.

The nozzle of the invention is typically used in conjunction with a conventional trigger sprayer which has a housing, a pump, a trigger, and a bottle coupling.

According to another embodiment, the door is separately molded rather than being molded together with a hinged coupling to the front of the nozzle. The separately molded door has a plurality of hooks (e.g., four hooks) which mate with slots in the front of the nozzle.

Additional objects and advantages of the invention will become apparent to those skilled in the art upon reference to the detailed description taken in conjunction with the provided figures.

### BRIEF DESCRIPTION OF THE DRAWINGS

FIGS. 1-4 are perspective views of a preferred embodiment of the nozzle according to the invention in its “as molded” state;

FIGS. 5-8 are perspective views of the nozzle of FIGS. 1-4 after the door is locked shut;

FIG. 9 is a side elevation view of a trigger sprayer incorporating the nozzle of FIGS. 1-8; and

FIGS. 10-12 are front and back side elevation views of an alternate embodiment of a nozzle with an unhinged locking door.

### DETAILED DESCRIPTION OF THE PREFERRED EMBODIMENTS

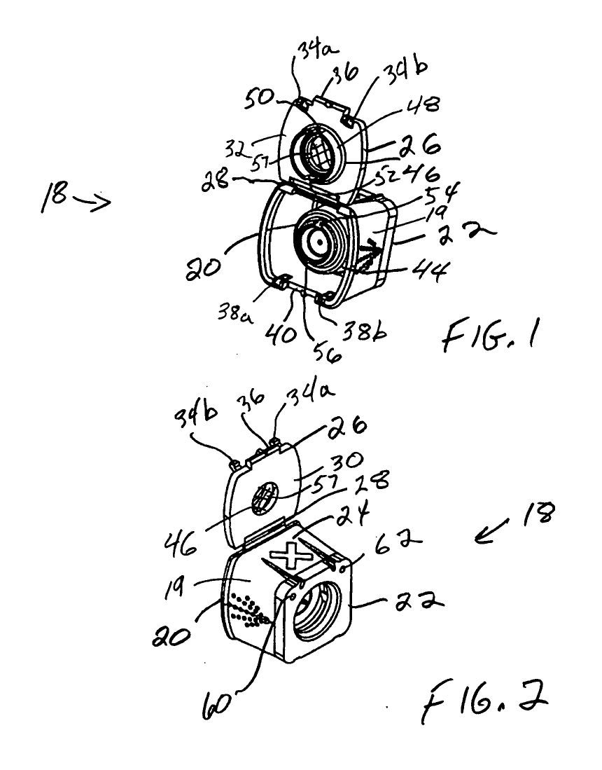

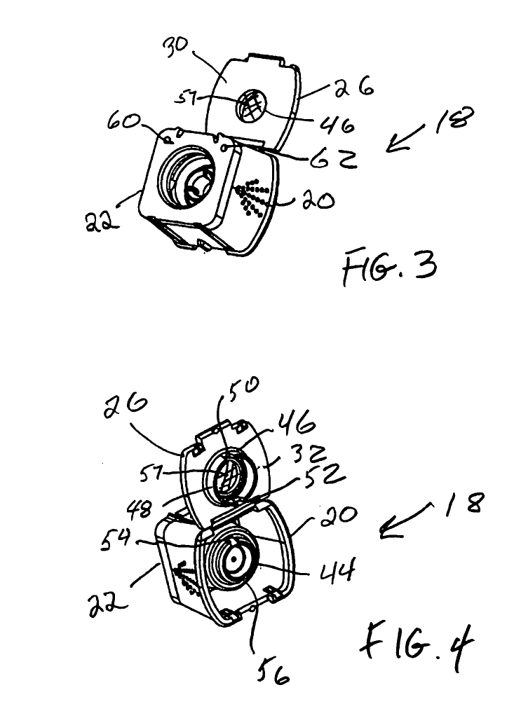

Turning now to FIGS. 1-4, a nozzle 18 according to the invention generally includes a nozzle body 19 having a front 20, a back 22, and at least one (preferably flat) side surface 24 extending therebetween. A door 26 is coupled to the nozzle by a live hinge 28 at the intersection of the front 20 and the side surface 24. The door 26 has an outer surface 30 and an inner surface 32 with at least one hook (preferably two) 34a, 34b extending from the inner surface of the door. As illustrated, a short tongue 36 extends between the hooks 34a, 34b. The front of the nozzle is provided with a pair of slots 38a, 38b with a short groove 40 between them.

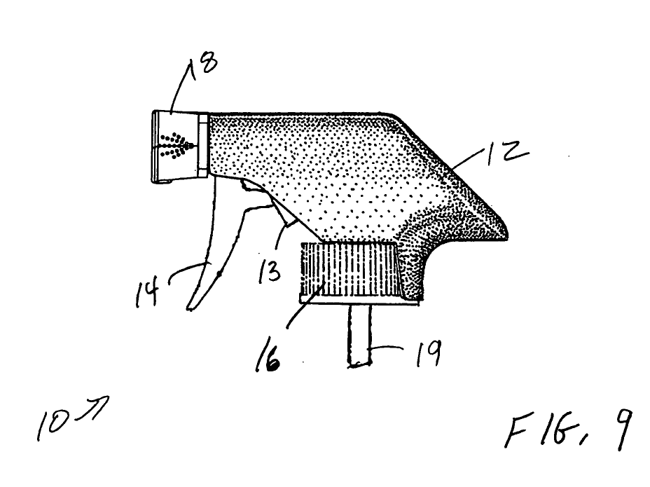

As illustrated, it can be seen that the nozzle body is generally cubic in shape having four sides in addition to the front 20 and the back 22. One of the four sides provides the previously described side surface 24. Inside the cubic structure there is a substantially cylindrical spray head 44. The nozzle 18 with the spray head 44 couple to a conventional trigger dispenser pump outlet in a conventional way as described below with reference to FIG. 9. Those skilled in the art will appreciate that the nozzle 18 is preferably rotatable about the axis of the spray head 44 and that rotation serves to open and close the fluid path through the spray head. As illustrated, indicia are provided on the sides of the nozzle to indicate whether the fluid path is opened or closed.

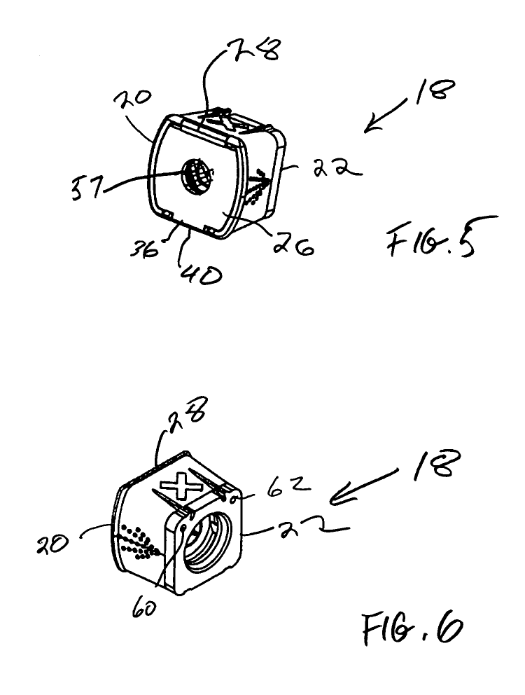

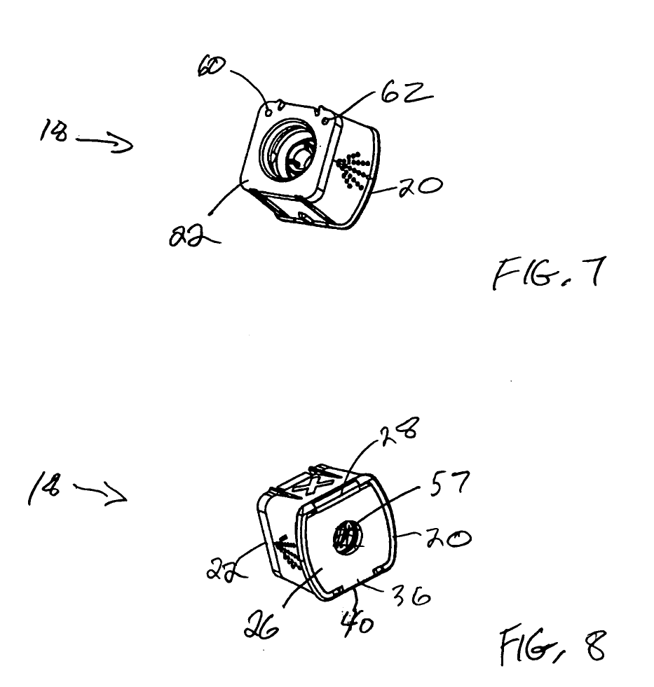

In accord with the invention, the door 26 has a circular portal 46 which, when the door is closed (FIGS. 5-8), is substantially coaxial with the spray head 44. On the interior surface 32 of the door 26, the portal 46 is surrounded by a short cylinder 48 which has a pair of diametrically opposed notches 50, 52. A circular screen 57 is located inside the cylinder 48. The screen may be insert molded or mechanically affixed. Alternatively, it may be formed as an integral part of the molded door. When the door is closed, the cylinder 48 surrounds the spray head 44 which is provided with matching notches 54, 56. The notches 50, 52, 54, 56 allow air from the atmosphere to enter the space between the spray head 44 and the screen 57. Thus, when the door is closed and the nozzle is rotated to the spray position, foam will be dispensed. FIGS. 2, 3, 6, and 7 also show two air holes 60, 62 which allow air to enter the interior of the nozzle from the back.

Referring now to FIGS. 5-8, after molding, the door 26 is folded on its hinge 28 so that the hooks lock into the mating slots with the tongue 36 lying within the groove 40. The engagement of the door to the front of the nozzle is preferably secure enough to prevent it from opening. Optionally, it is secure enough to prevent it from opening while it is glued or chemically or sonically welded shut. The embodiment of FIGS. 1-8 is the presently preferred embodiment because it is easy to mold as a single piece. It is easy to assemble by folding the door closed on its hinge and easy to glue or weld shut (if desired) because of the secure locking of the door.

An alternate proposed embodiment does not require hooks. In the “no hooks” embodiment, frictional engagement of the door to the front of the nozzle is achieved solely by the tongue and groove and/or engagement of the cylinder 48 with the spray head 44 and gluing or welding is preferably applied to keep it shut.

From the foregoing, those skilled in the art will appreciate that the preferred method of manufacturing the nozzle is to mold the screen as an integral part of the door which is molded together with the live hinge coupling to the nozzle. After this single molding step, the door is closed on its live hinge and held closed by hooks without the need for glue or welding.

Turning to FIG. 9, a trigger dispenser 10 according to the invention includes a pump housing 12 covering a trigger operated pump 13, a trigger 14 coupled to the pump, a bottle connector 16, a nozzle 18 and an inlet tube 19. The inlet tube 19 is coupled to the inlet of the pump 13 and the outlet of the pump is coupled to the nozzle 18. When the dispenser is coupled to a bottle (not shown) of liquid with the inlet tube 19 extending into the liquid and the trigger 14 is squeezed, the pump 13 draws liquid through the inlet tube 19 and dispenses it out through the nozzle 18.

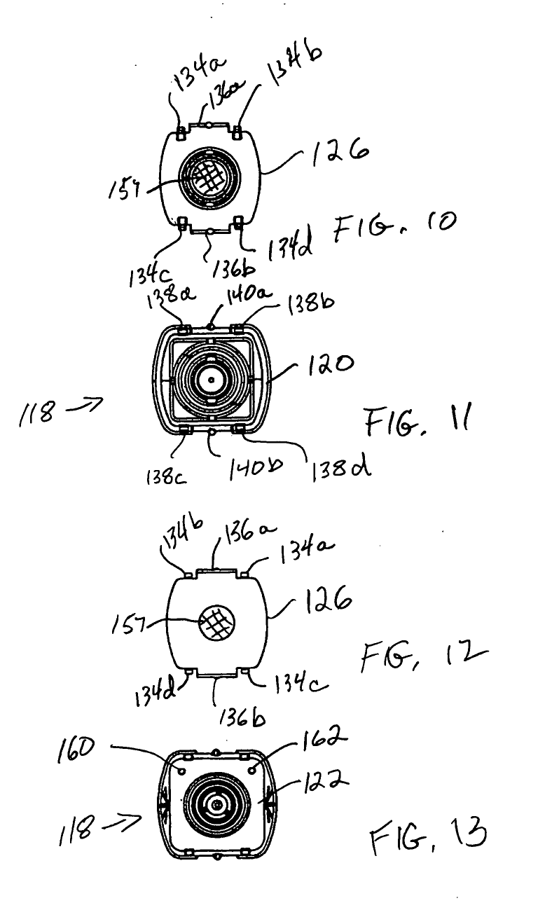

FIGS. 10-13 illustrate an alternate embodiment where the nozzle door 126 is molded as a separate piece. The nozzle 118 is otherwise similar to the nozzle 18 with similar reference numerals (increased by 100) referring to similar parts. By eliminating the hinge, it is necessary to couple the door 126 to the front 120 of the nozzle 118 where the hinge previously resided. To accomplish this, four hooks 134a-134d and two tongues 136a, 136b are provided on the door 126. Correspondingly, four slots 138a-138d and two grooves 140a, 140b are provided on the front 120 of the nozzle 118. This embodiment requires that the door be aligned with the front of the nozzle before it can be locked to it.

There have been described and illustrated herein several embodiments of methods of making a foam/spray nozzle for a dispenser apparatus. While particular embodiments of the invention have been described, it is not intended that the invention be limited thereto, as it is intended that the invention be as broad in scope as the art will allow and that the specification be read likewise. Thus, while various locking mechanisms have been described for keeping the door engaged with the nozzle body, it will be appreciated that other mechanisms could be utilized. In fact, it is possible to use an external mechanism to keep the door engaged with the nozzle body. It will therefore be appreciated by those skilled in the art that yet other modifications could be made to the provided invention without deviating from its spirit and scope as claimed.

What is claimed is:

1. A method of making a nozzle for a trigger dispenser, comprising:
insert molding a nozzle body with a screen, said nozzle body containing a spray head and coupled by a live hinge to a door having a portal with the screen in the portal, wherein said nozzle body, said spray head, said door and said live hinge are molded in the mold with the screen;
folding the door on the live hinge so that the door covers the spray head; and
substantially permanently closing the door on the nozzle body with the door covering the spray head.

2. The method according to claim 1, wherein:
said substantially permanently closing comprises frictional engaging.

3. The method according to claim 2, wherein:
said substantially permanently closing also includes gluing or welding.

4. The method according to claim 1, wherein:
said door has an interior door surface having a first hook extending therefrom, and said nozzle body has a first mating slot, and said substantially permanently closing the door on the nozzle body includes engaging said first hook in said first mating slot.

5. The method according to claim 4, wherein:
said interior door surface has a second hook extending therefrom, and said nozzle body has a second mating slot, and said substantially permanently closing the door on the nozzle body includes engaging said second hook in said second mating slot.

6. The method according to claim 5, further wherein:
said door includes a tongue which extends between said first and second hooks,
said nozzle body defines a groove lying between said first and second slots, and
said substantially permanently closing the door on the nozzle body includes causing said tongue to engage said groove.

7. A method of making a nozzle for a trigger dispenser, comprising:
molding a nozzle body containing a spray head and coupled by a live hinge to a door having a portal with an integral screen in the portal;
folding the door on the live hinge so that the door covers the spray head; and
substantially permanently closing the door on the nozzle body with the door covering the spray head.

8. The method according to claim 7, wherein:
said substantially permanently closing comprises frictional engaging.

9. The method according to claim 7, wherein:
said substantially permanently closing also includes gluing or welding.

10. The method according to claim 7, wherein:
said door has an interior door surface having a first hook extending therefrom, and said nozzle body has a first mating slot, and said substantially permanently closing the door on the nozzle body includes engaging said first hook in said first mating slot.

11. The method according to claim 10, wherein:
said interior door surface has a second hook extending therefrom, and said nozzle body has a second mating slot, and said substantially permanently closing the door on the nozzle body includes engaging said second hook in said second mating slot.

12. The method according to claim 11, further wherein:
said door includes a tongue which extends between said first and second hooks,
said nozzle body defines a groove lying between said first and second slots, and
said substantially permanently closing the door on the nozzle body includes causing said tongue to engage said groove.
